(19) United States
(12) Patent Application Publication
(10) Pub. No.: US 2015/0141085 A1
(43) Pub. Date: May 21, 2015

(54) MOBILE COMPUTING DEVICE FOR BLIND OR LOW-VISION USERS

(71) Applicant: ZONE V LTD., Cambridge (GB)

(72) Inventors: Frank Nuovo, Los Angeles, CA (US); Peter Ashall, Wokingham (GB); Abhijit Naha, Ipswich (GB)

(21) Appl. No.: 14/408,190

(22) PCT Filed: Jun. 14, 2013
(86) PCT No.: PCT/GB2013/051565

§ 371 Date: Dec. 15, 2014

(30) Foreign Application Priority Data
Jun. 14, 2012 (GB) 1210566.4
Jun. 14, 2012 (GB) 1210570.6
Jun. 14, 2012 (GB) 1210572.2
Jun. 14, 2012 (GB) 1210577.1
Jun. 14, 2012 (GB) 1210581.3
Jun. 14, 2012 (GB) 1210583.9
Jun. 14, 2012 (GB) 1210586.2
Jun. 14, 2012 (GB) 1210589.6
Jun. 14, 2012 (GB) 1210592.0
Jun. 14, 2012 (GB) 2010588.8

(51) Int. Cl. H04M 1/725; H04M 1/02

(52) U.S. Cl. CPC H04M 1/72594; H04M 1/026
USPC 455/575.1

(57) ABSTRACT

Mobile computing device including a physical feature which defines the centre-line of the device across the short and/or long axes of the device.

### BACKGROUND OF THE INVENTION

1. Field of the Invention

This invention relates to a mobile computing device, such as a smartphone or tablet, with specific features that assist blind or low-vision users. The computing device may also appeal to general users with good vision.

2. Description of the Prior Art

Smartphones are in widespread use, but the dominant, typical form factor, a sheet of touch-screen glass in a thin casing, can be challenging for blind or low-vision users to operate confidently and with assurance. Nevertheless, smartphones such as the iPhone from Apple are popular with blind and low-vision users because of the high-quality of manufacturing and materials, leading to an engaging tactile experience, and the large number of third party apps specifically for the blind and low-vision users.

Nevertheless, there is great scope for improving the smartphone and tablet user experience for blind and low-vision users. This specification describes innovations in this field.

### SUMMARY OF THE INVENTION

The invention is a mobile computing device including a physical feature which defines the centre-line of the device across the short and/or long axes of the device.

Additional concepts or features include the following:
Device has a left-right asymmetrical shape.
Device includes a front facing speaker grill with multiple front-facing audio output ports that lie adjacent to the keys of a physical keyboard.
Device includes a haptic feedback touch screen display plus haptic feedback physical keys, all mounted on the same base, and vibrationally insulated from the rest of the handset by a flexible mounting.
Device includes a keyboard in which all physical keys provide different touch feedback sensations from adjacent keys, e.g. by being made of different materials or having a different shape.
Device in which, when the user touches a physical key, then there is both visual confirmation feedback on the display, and audio confirmation feedback. Actual selection of the key is then confirmed with haptic feedback.
Device has a separate camera that is not integrated into the camera body but instead connected via a flexible leash.
Device includes a drop sensing app that automatically triggers an audible alert to assist the user in locating the handset.
Device has multiple microphones to accurately detect a tap source's location on the handset casing.
Device includes colour sensing software—the colour name is spoken with tonal variations that encode colour variations such as intensity.

### BRIEF DESCRIPTION OF THE DRAWINGS

The invention is described with reference to the accompanying drawings, in which:

FIGS. 1 and 2 are perspective views of a smartphone in accordance with the invention.

FIG. 3 is a front view of the smartphone.

FIGS. 4, 5 and 6 are close-up views showing the centre-line ridges.

FIG. 7 is a close-up showing the front-facing acoustic ports.

FIG. 8 shows the physical keyboard.

FIG. 9 is a sequence showing the audio, visual and haptic feedback when the user hits the numeric key ‘3’.

FIG. 10 is a sequence showing the audio, visual and haptic feedback when the user finds and enters the numeric key ‘1’ and then searches for and finds numeric key ‘0’.

FIG. 11 depicts the smartphone reading out the numbers displayed on screen as the user moves his finger over them.

FIG. 12 shows how the smartphone is divided into quadrants by cross-hairs.

FIGS. 13-17 are images of an alternative smartphone design.

FIG. 18 schematically depicts using multiple microphones to find a tap location on the body of the smartphone.

FIGS. 19 and 20 shows a camera and/or lens mounted on a flexible leash.

FIG. 21 depicts how different colours and tones can be represented audibly.

### DETAILED DESCRIPTION

Mobile computing devices in accordance with this invention may implement a number of high-level design principles for mobile telephone handset design, such as:
Design based on tangible user benefits of usability and long lasting design quality.
Sight, sound and touch amplified
Easy to navigate by feel—position of hands and location of important parts can be sensed by touch
Unique topography makes it easy to identify where you are touching and holding the device
Combining physical features with haptics to create the best possible interactive user experience, whether for sighted or unsighted.

The specific concepts and features of one implementation include the following nice core concepts, which can each be independently implemented in a mobile computing device, and also combined with any one or more of the listed concepts and features. The term ‘handset’ will be used to refer to the device and covers any form of mobile computing device, such as a smartphone, tablet or phablet.

### 1. The Handset has a Left-Right Asymmetrical Shape

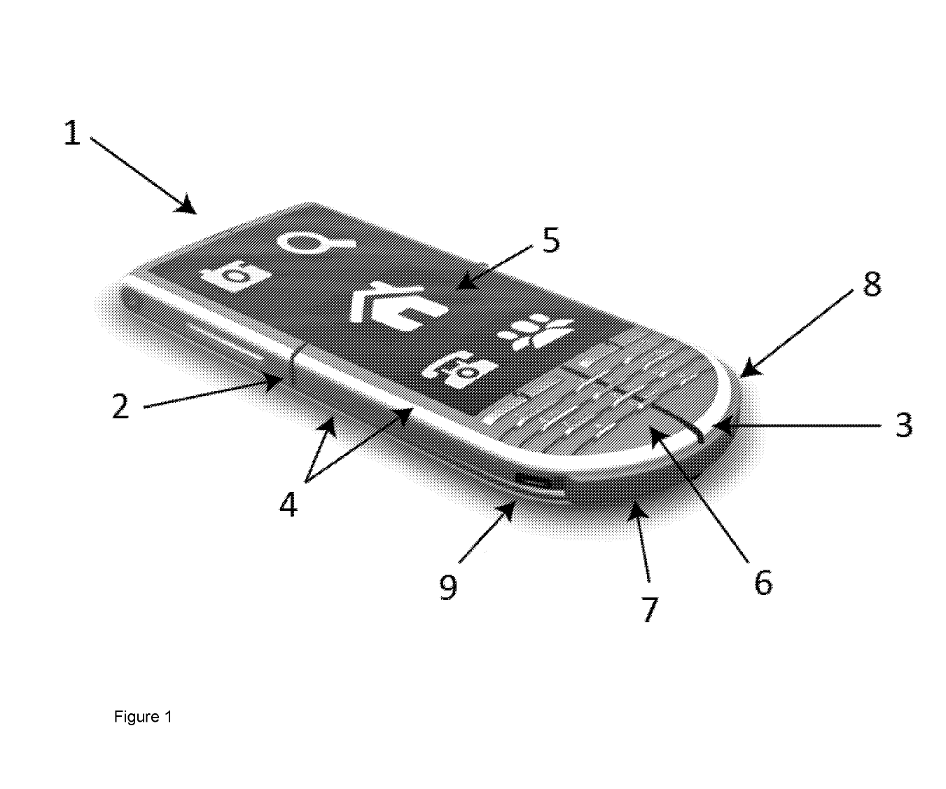

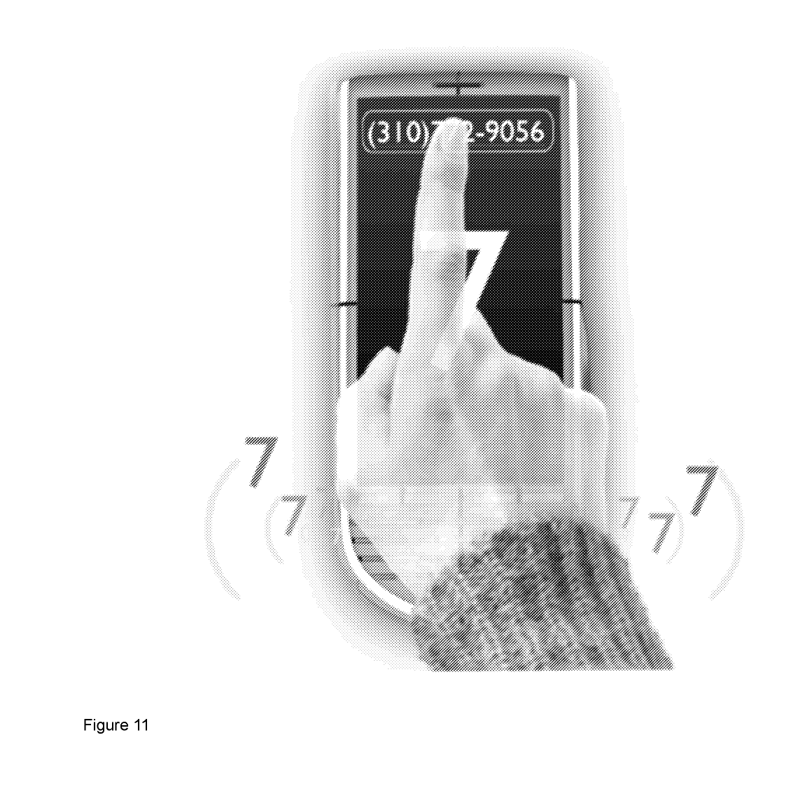

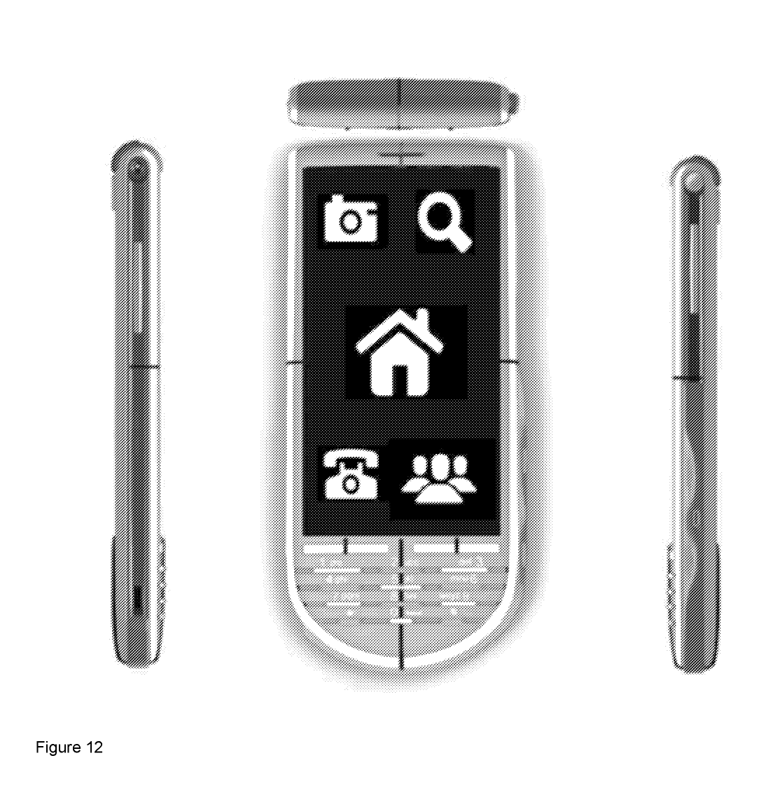

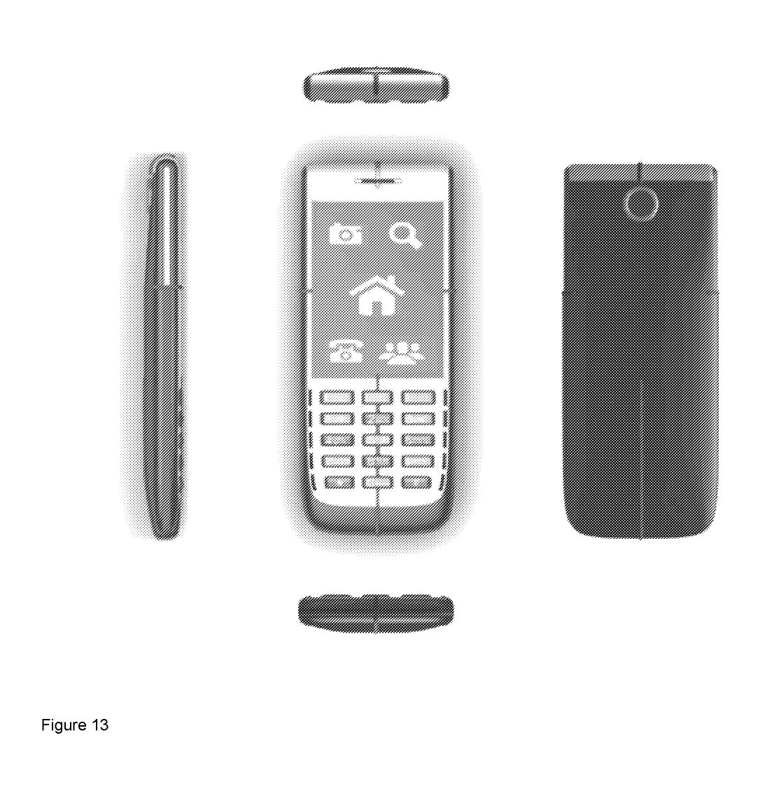

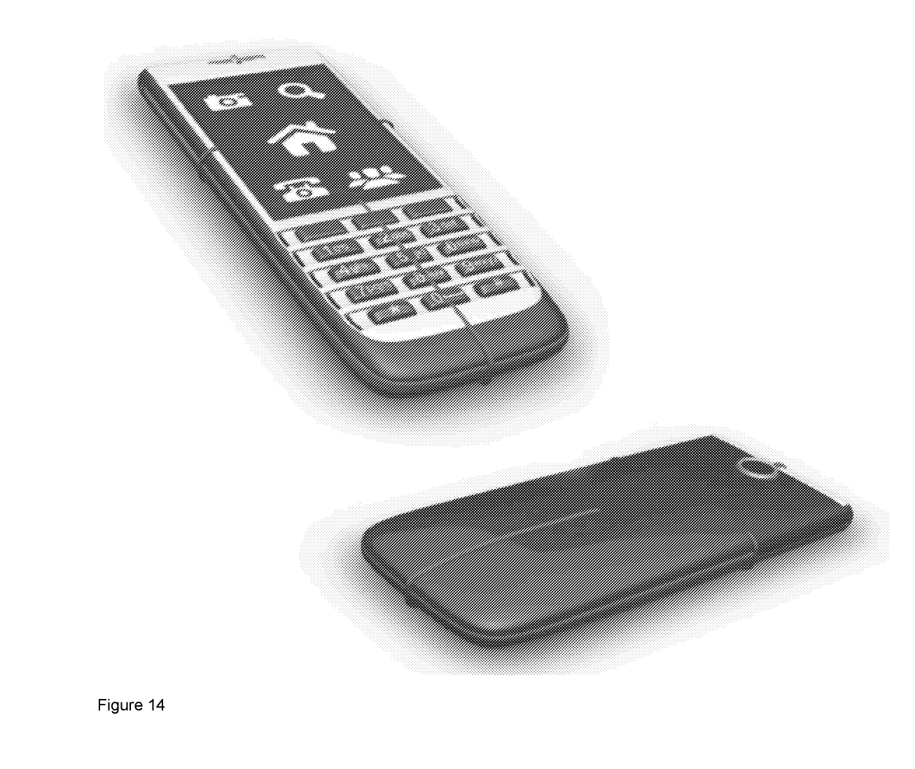

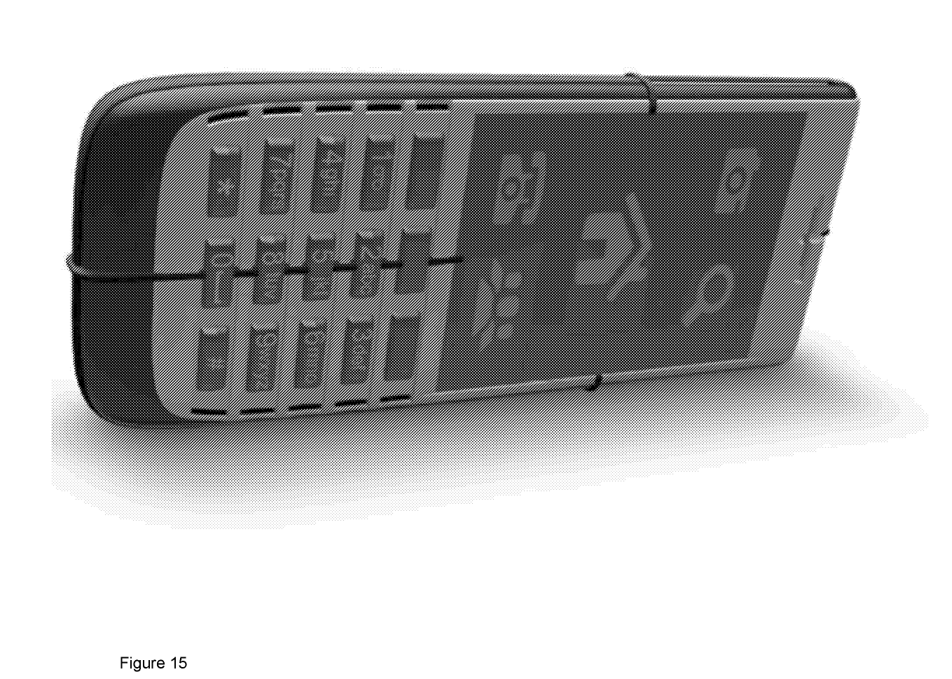

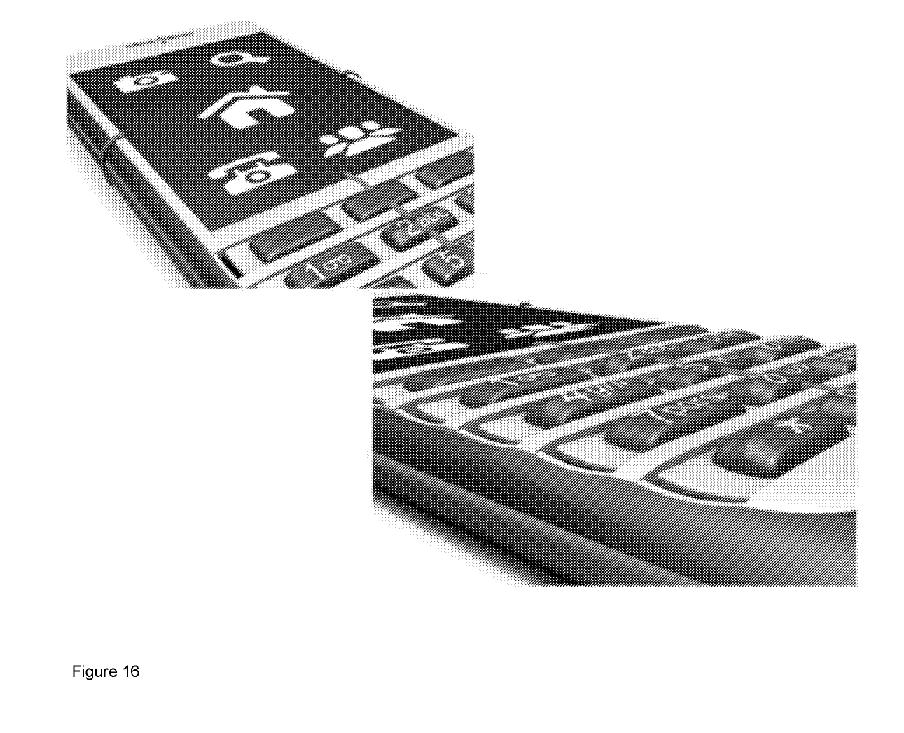

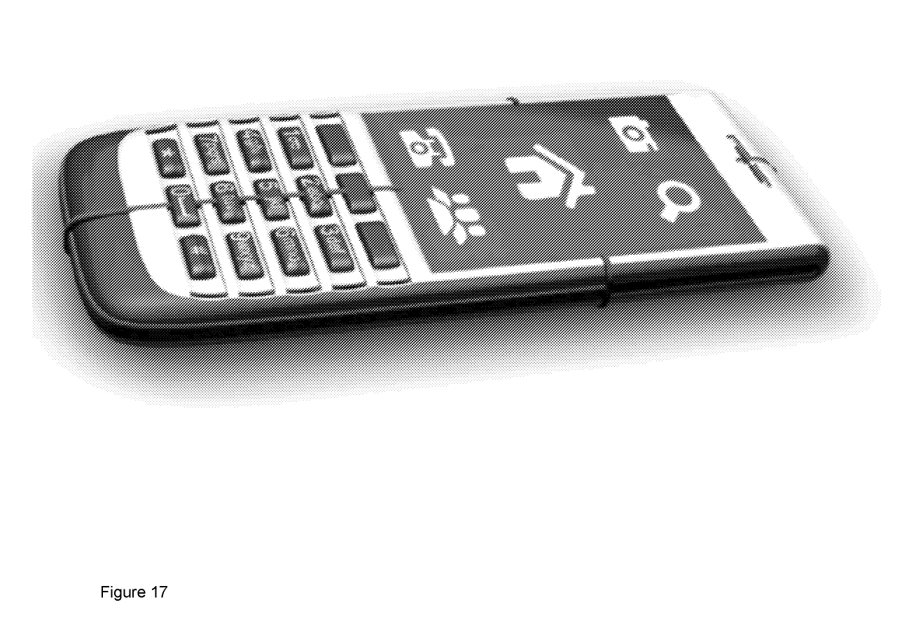

The handset includes a touch screen display 5 and a physical keyboard 6 and the main body of the device has a left-right asymmetrical shape (e.g. it is not a conventional shape that is left/right symmetrical like a conventional candy bar phone or iPhone). It is designed so that a blind or partially sighted user can immediately orient the handset correctly. FIGS. 1-12 depict one design of the smartphone with left-right asymmetry of the actual body of the device; FIGS. 13-17 depict an alternative design with a smaller touchscreen, and a larger keyboard with larger keys.

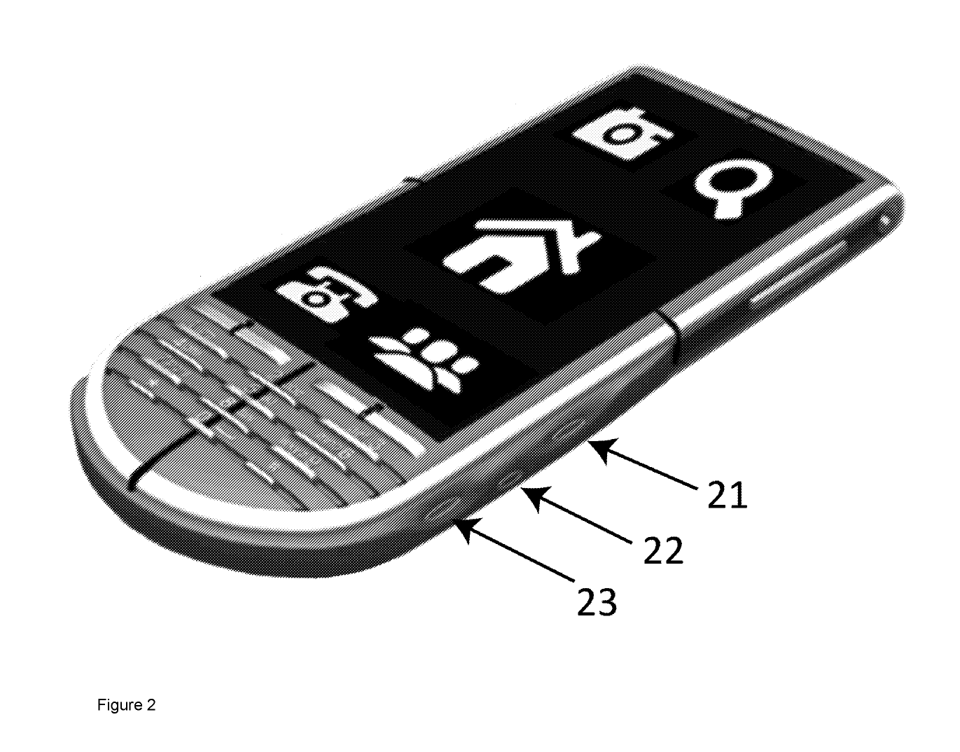

Referring to FIG. 1, the shape of the right hand-side of the body of the device can be subtly different from, and hence not a mirror image of, the left side. Note that this is different from the body being symmetrical but having an asymmetric placement of buttons or controls. When the user picks up the phone, it is immediately obvious by feel alone whether the device is correctly oriented—and if it is not correctly oriented, it is immediately obvious how to correctly re-orient the phone. There are many different ways of implementing this concept.
a bumper, shown at 8 in FIG. 1, at the bottom of the phone 1 which continues up the right hand side slightly further than it continues up the left hand side 7.
that bumper can also include physical buttons for useful functions (e.g. off-on, take a picture button with integral digital camera, emergency help button, and any other one or more useful buttons—see 21, 22 and 23 in FIG. 2). For the partially sighted or blind, placing these important buttons in the bumper is especially useful since the bumper is the first thing that the user will consciously be feeling for when he or she picks up the device.
The end of the bumper can also define the region 9 in the handset side for the power socket (or other ports/sockets are). Often, ports (e.g. mini or micro USB) and other kinds of sockets are difficult for the blind or partially sighted to reliably locate (because they are small recessed features) and hard to reliably insert a jack into. The bumper both locates the port position and provides a reassuring part of the device to hold or grip when inserting the jack or plug.
A hard plastic structure 4 separates the upper and lower surfaces.
   2. The Handset Includes a Physical Feature which Defines the Centre-Line of the Handset

This dedicated feature facilitates the blind or partially sighted user in correctly orienting the phone and in enabling them to rapidly construct and confirm their ‘mental map’ of the handset and the location of its buttons and screen in relation to their own fingers and hands. It is cognitively better to have a dedicated feature than multi-purpose features since that is easier and faster for the user—for example, although a specific key on the keyboard might have a small raised feature which, once found, enables the user to correctly orient the device, it is faster and easier for the user to have dedicated features which solely define the centre-line(s) of the device. For example, this device includes centre-line 3 down part of the middle of the phone along its long axis; and/or centre-line 2 down the middle of the phone along its short axis; both centre-lines can extend along part or all of the sides of the device and the back surface.

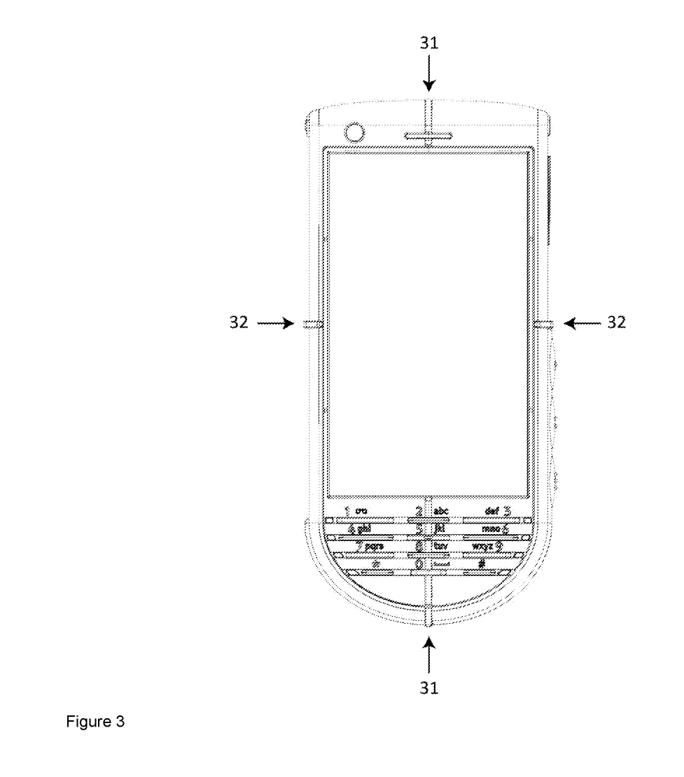

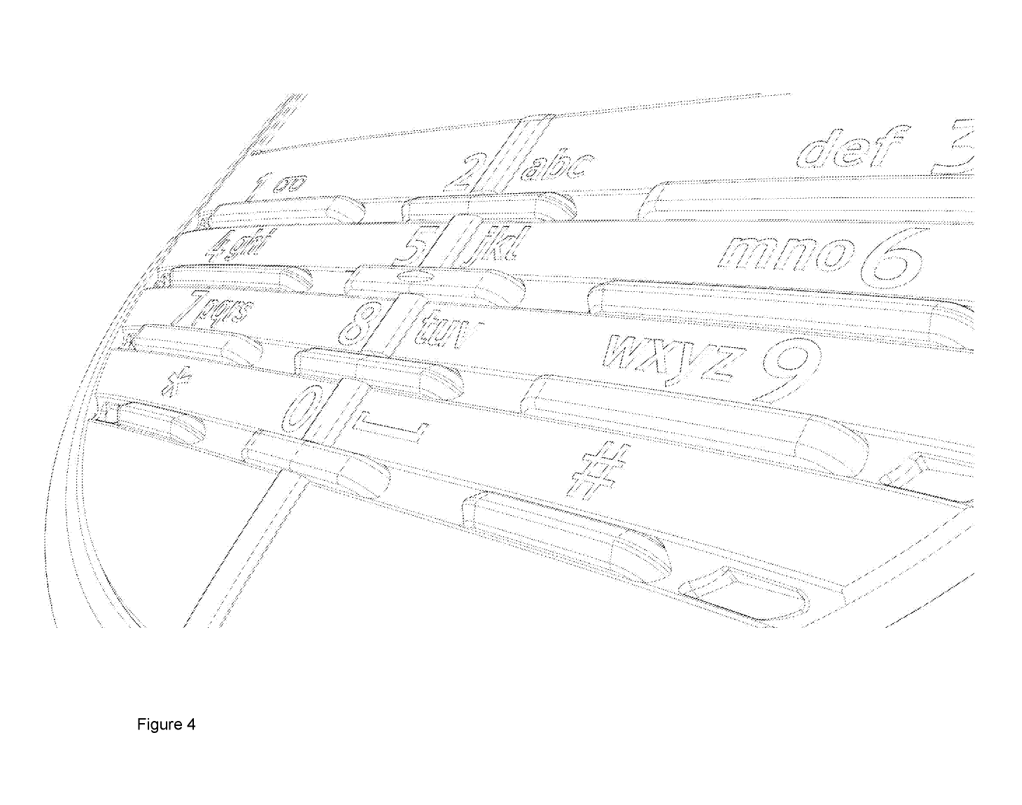

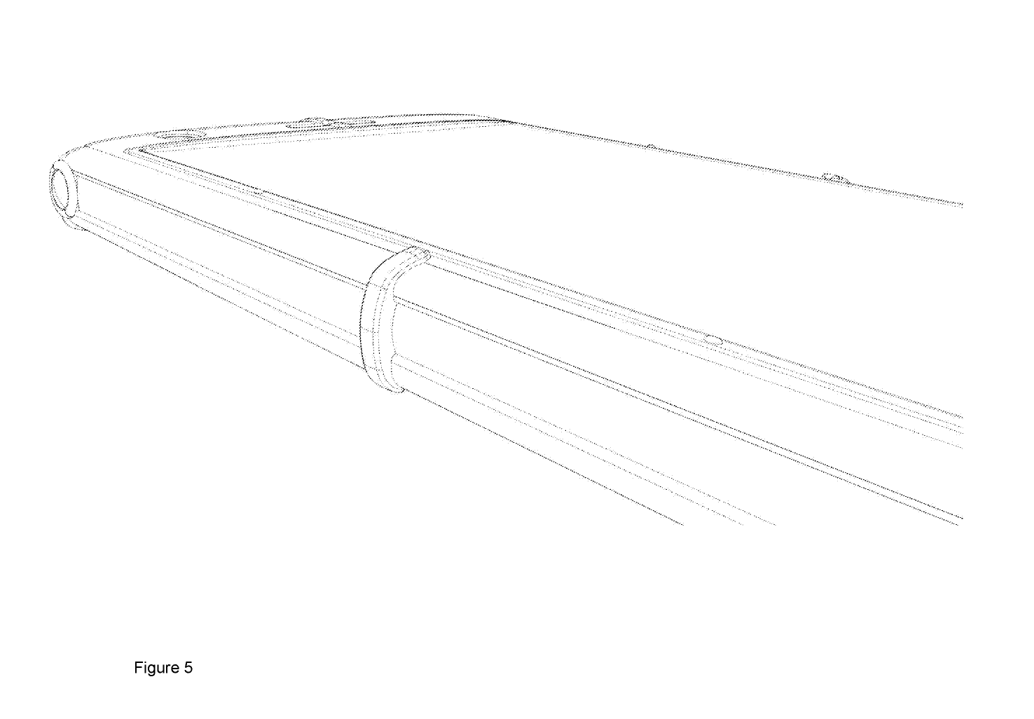

The centre-line feature can be a thin, raised ridge (see FIG. 3: 31) running along part of the centre-lines; an orthogonal thin, raised ridge 32 can run along part of the other centre-line of the handset, forming part of a ‘cross-hair’ arrangement. The ridge can be picked out in a colour that contrasts strongly with the colour used on the rest of the body of the handset. FIG. 4 shows how the centre-line 31 runs through the physical keyboard, providing context and re-assurance for the user's fingers as they move across the keyboard, searching for the correct keys or the centre of the touch screen display. FIG. 5 shows how the centre-line 32 extends along the side edge of the device.

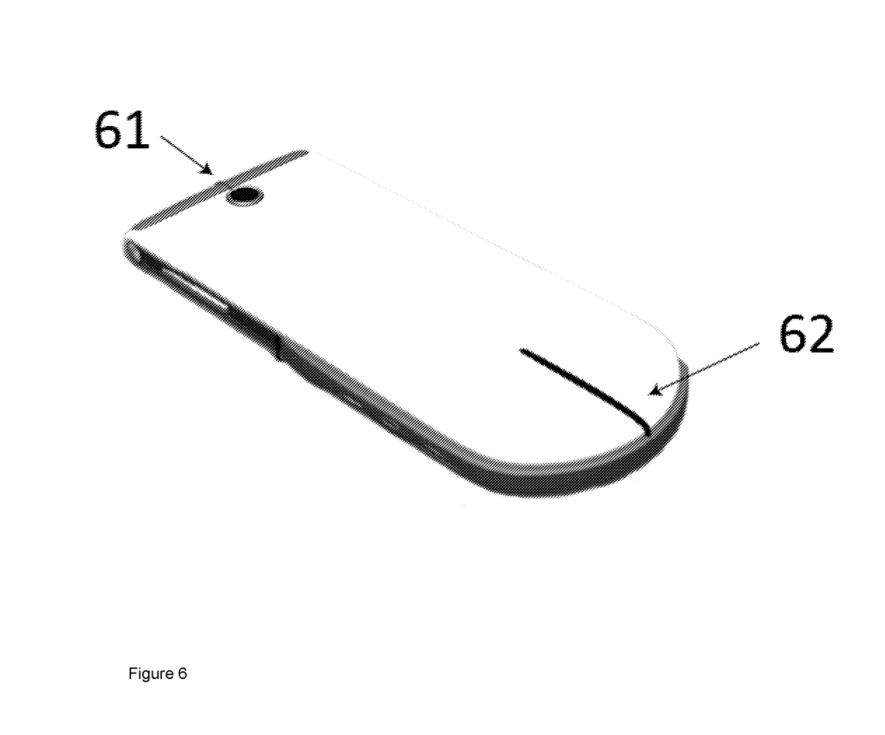

The centre-line ridges can be formed on the sides of the device, providing tactile context and re-assurance of the position of the device in the user's hands. The ridge (FIG. 6-61) along the long-axis can also lead to the camera lens (front and/or rear lenses); hence, if a user is touching the ridge 61, they can be confident that they are not blocking the lens. The lower portion 62 of the ridge also assists the user in correct hand positioning.

3. Front Facing Speaker Grill Includes Multiple Front-Facing Audio Output Ports that Lie Adjacent to the Keys of the Physical Keyboard

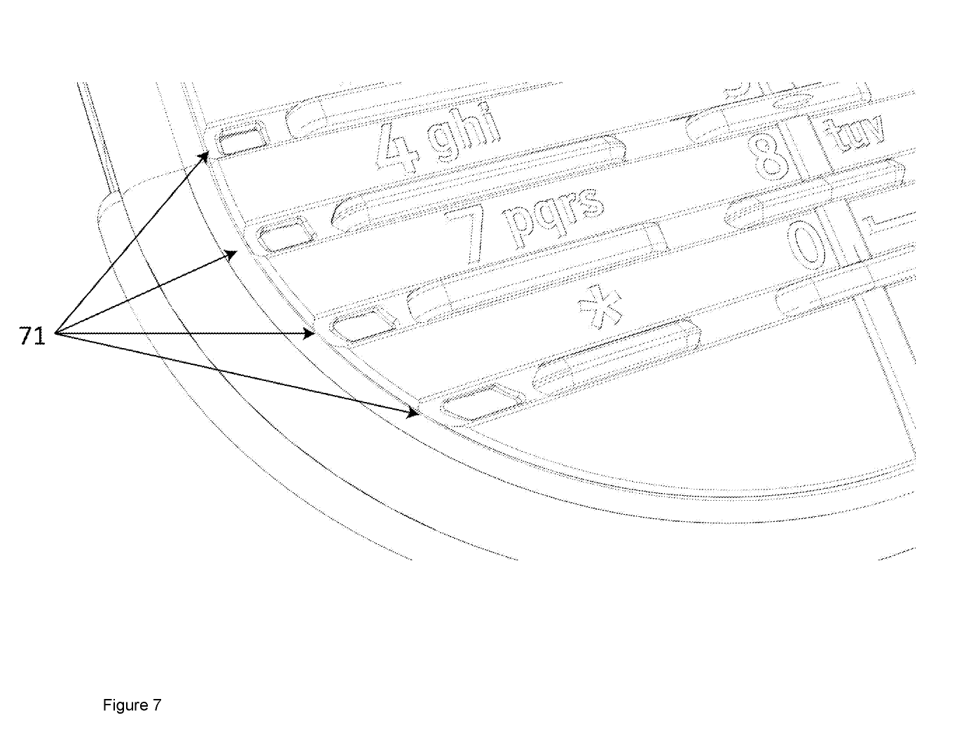

By providing for multiple audio output ports (FIG. 7-71) that lie adjacent to the keys of the physical keyboard, it is possible to have a large speaker system with an large acoustic resonance chamber—the acoustic resonance chamber can be positioned underneath the circuit board that the keyboard is integrated with.

The audio output ports can be positioned along the side edges of the keyboard, so where there are four rows of keys, then there would be four audio output ports along each side of the keys. The audio output ports can also be formed as apertures in channels formed into the keyboard; a single channel can appear to extend the width of the keyboard, terminating at each end in an audio output port. The ports can be acoustically tuned.

4. Handset Includes a Haptic Feedback Touch Screen Display Plus Haptic Feedback Physical Keys, all Mounted on the Same Base, and Vibrationally Insulated from the Rest of the Handset by a Flexible Mounting

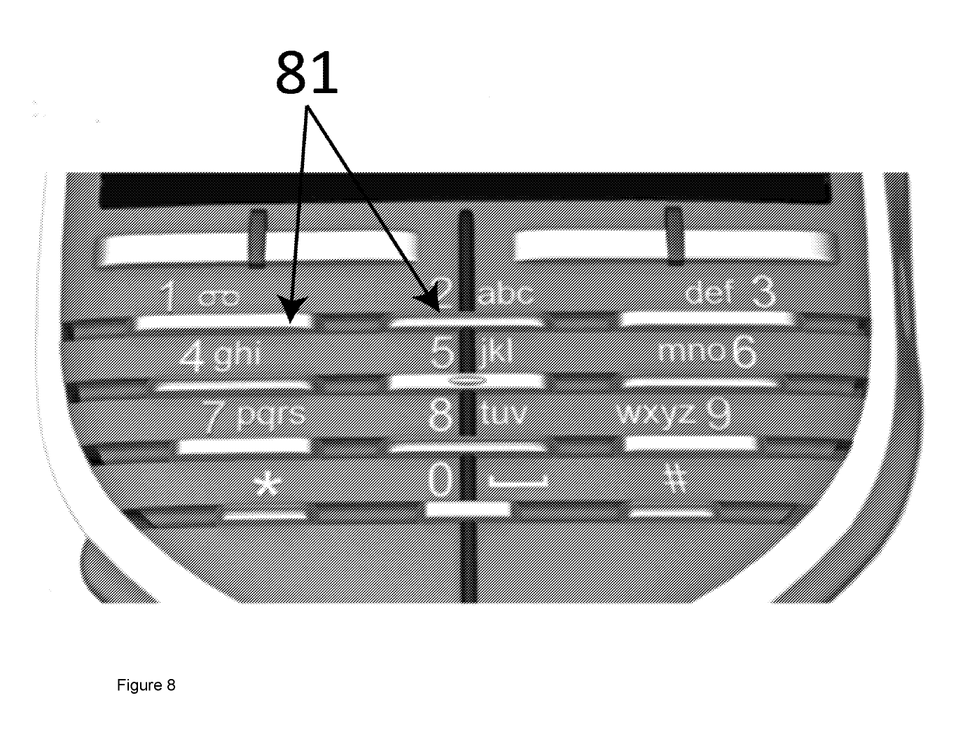

The handset includes both a haptic touch screen 5 as well as haptic physical keys 6 (see also FIG. 8 for a close up view of the keyboard with keys 81). Typically, the keys are capacitive keys with some form of haptic actuation or module, so that each key can provide haptic feedback; this feedback can be far subtler and more complex that the feedback from a conventional physical key. For example, the key can provide different surface textures, or feedback that alters progressively the harder a user touches the key etc.

This haptic keyboard can be implemented in several different ways, such as a dedicated haptic system for both the display area and the keyboard, or a single haptic system providing tactile feedback across both the touch screen and the physical keys. Typical haptic technology is ViviTouch™ from Active Muscle, Inc., in which an electro-active polymer module sits just below the display screen and keypad, enabling a user to feel haptic touch sensations that mimic the pressing of a key or moving a control slider etc.

The keyboard area and the touch screen are both mounted on the same base, which is vibrationally insulated from the rest of the handset by a flexible mounting, such as a rubber barrier or seal. This ensures that the haptic vibrations are not propagated to parts of the handset where they would confuse the user—for example if a user is holding the handset, and is being given haptic feedback with his finger touching the touch screen, but there is some residual vibration reaching the back of the handset, then that can confuse the physical feedback; for blind and partially sighted users, clear and unambiguous physical feedback is especially important.

Keyboards often have a small raised button or indent on a specific button (usually numeric key ‘5’) to allow the user to orient their fingers on the keypad by touch alone. We extend that principle by providing (see FIG. 8) that adjacent keys on the same row (and/or column) of a keyboard have a different feel—for example, their shape, and/or material could differ—the tactile qualities of keys can therefore alternate across a row and/or column—for example, keys could be alternately hard (metal) and then soft (rubber). The keys in the keyboard have a 5.0 mm centre-to centre spacing and sit within channels to aid their rapid location by touch alone. In this implementation, keys in a given row have an alternating soft top (eg rubberized) and then a ridged top. This give much better feedback to the user and confirmation of the keys being touched.

5. When the User Touches a Physical Key, then there is Both Visual Confirmation Feedback on the Display, and Audio Confirmation Feedback. Actual Selection of the Key is then Confirmed with Haptic Feedback.

The capacitive keys in the keyboard may activate a large letter or number graphic shown on the display and then an audio voice speaking out aloud the letter or number. Confirmation of selection of that letter or number is then confirmed with haptic feedback on the physical key.

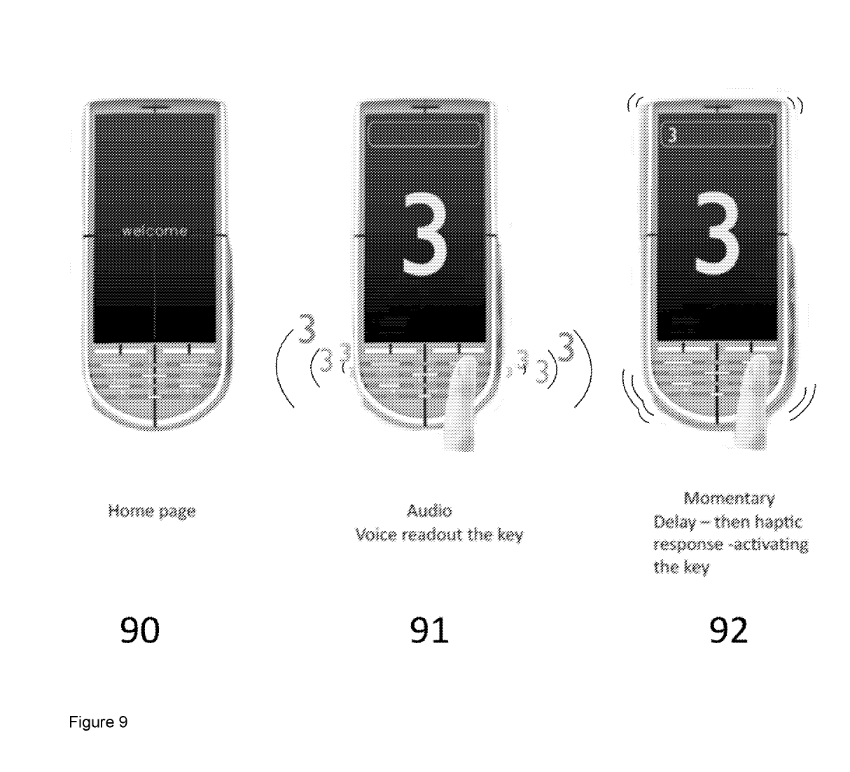

This may be implemented in a two-state key and related control software that enables (i) initial selection and (ii) actual confirmation. For example, as shown in FIG. 9, starting with the smartphone showing the welcome home page screen, if the user touches the numeric keypad for number ‘3’, then the handset speaker announces 91 the number ‘3’ and the number ‘3’ is displayed on the display. If the user wishes to confirm selection of numeric ‘3’ (i.e. actually enter or use it), then he does so using the normal key interaction approach (e.g. for a mechanical key, confirmation may occur on the ‘key up’ movement. For a capacitive key, confirmation of a key can also be designed to occur when the user lifts his finger off that key, or if the finger is kept on the key for more than a predefined time, say 0.5 seconds). Confirmation is associated with suitable haptic feedback 92, such as a vibration or short pulse on the numeric key 3, or a simulated up/down movement of that key. An audible click may also be added.

Where a two-state key is not used, so that selection/confirmation is completed in a single action, then the same approach of providing visual and audio confirmation can occur, however, if the user mistakenly selected that key, the user has then to delete it using a conventional delete or backspace operation (when the user selects the delete/backspace, the device displays a large ‘delete/backspace’ icon or graphic and the speaker says ‘delete’ or ‘backspace’).

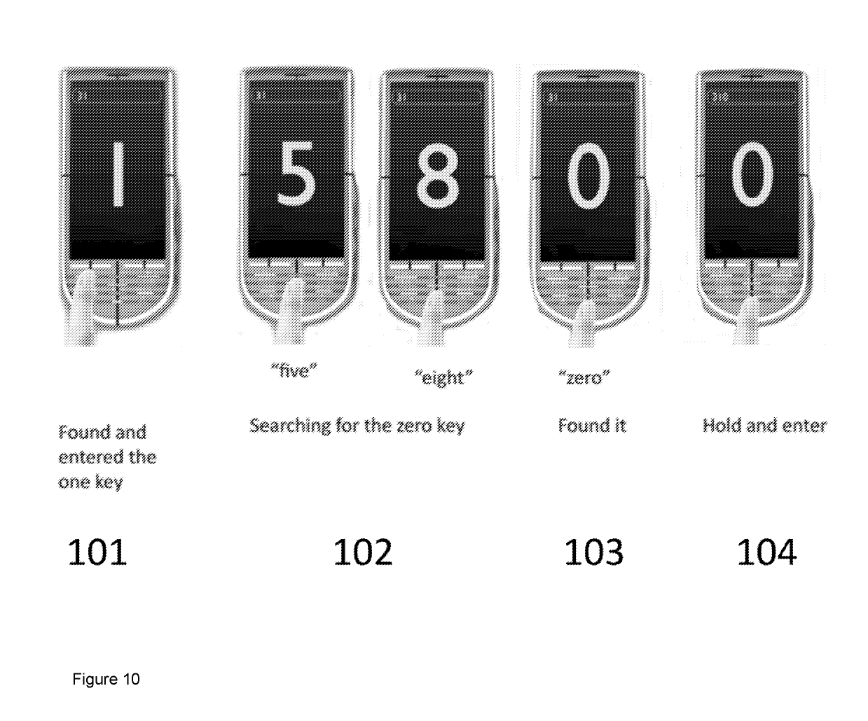

The visual and audio confirmation is not limited to confirming numbers, and can allow the user to discover the functions of any of the physical keys—touching them will cause an audio and visual explanation of their function (as with a conventional handset UI, the function of a physical key may also alter—i.e. be context specific). FIG. 10 depicts the user having found end entered numeric ‘1’ key at 101. He then searches for the numeric ‘0’ key by moving from the numeric ‘5’, up to the numeric ‘8’, with the device speaking out aloud each of those numbers 102, and then down that column to the numeric ‘0’ key, with the device again speaking out aloud ‘0’ 103. The user holds (or otherwise selects) numeric ‘0’ key and receives a haptic confirmation 104 of selection by the numeric ‘0’ key pulsing for a moment.

If the touch-screen displays is displaying a number or word, then the user can trace his fingers slowly over that number or word and the individual numbers or letters are then read back by the phone. With words, the device can read back entire words using on-device speech synthesis software.

6. The Handset has a Separate Camera that Isn't Integrated into the Camera Body

The camera is a very important feature of a device for the blind or partially sighted. One disadvantage of current cameraphones is that the camera is permanently integrated into the body of the phone. In this implementation, the handset may include a camera that is not integrated into the handset body, but is instead physically tethered, separable or separate (a conventional rear and/or front facing camera can also be provided in the main body). For the blind or partially sighted, having the camera tethered, separate or separable allows them more flexibility in positioning the camera exactly where they need it, whilst also keeping their handset where they need it too.

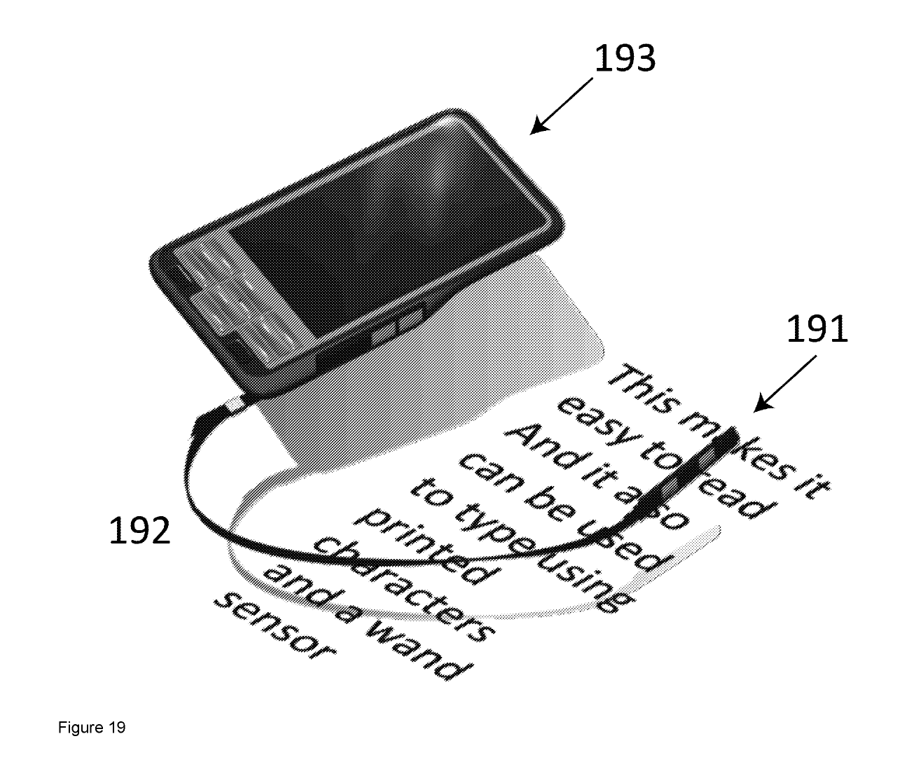

FIG. 19 shows how the camera or its lens and sensor unit 191 could be placed on a wand or leash 192 or other shape of unit that is physically tethered to the handset 193; the connection could be permanent or the wand/unit could be snapped off from the handset, only being connected wirelessly (e.g. Bluetooth). The camera or lens sensor could magnetically latch back to the handset body so that the leash forms a carrying loop.

The tethered camera can provide a magnified image of text to aid reading or object identification. The camera could be placed close to the text to be read and the magnified image displayed on the handset—the user can then place the handset close to his/her eyes for easy and more comfortable viewing—something not possible where the camera is integrated into the handset. A zoom function can be provided, with controls on the handset, to allow fast and easy zooming of the image.

With sophisticated, (probably) cloud-based object recognition (which could be purely machine based or a machine-human assisted hybrid), it can enable a user to simply point the camera at a street scene and for the street to be recognized, or at least (especially in combination with GPS) the user's orientation on a street to be established. The handset can then describe the location and provide a clear, simplified graphic of the street orientation and possibly directions to a destination. The same approach can be taken to recognizing and audibly describing objects and buildings.

Optical character recognition could also be provided—the user could for example point the camera at a newspaper or ticket etc. and the OCR (local to the handset or cloud-based, or a combination) could then interpret the scene. The handset could then display the text greatly enlarged on the handset display and/or read out the text. Facial recognition could also be provided; the user could point the camera at a person and the handset could speak that person's name if their face has been recognized.

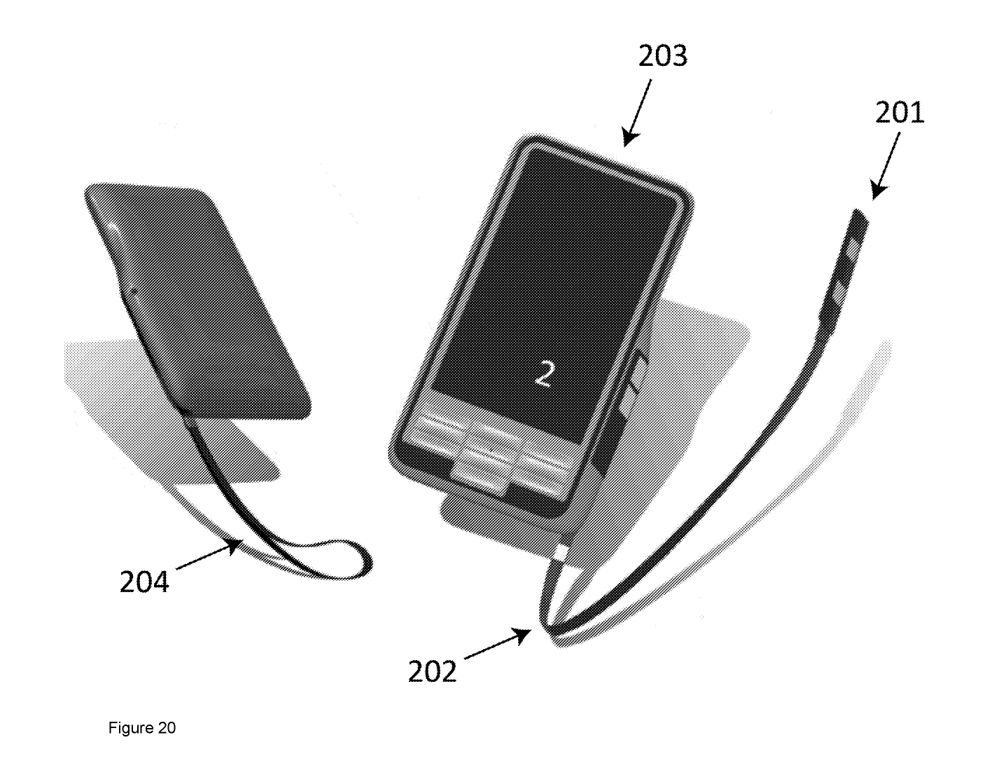

The remote wand (FIG. 20-201) can form into a carrying loop or strap 204 attached to the main body of the handset 203. It would be capable of being attached to the user's jacket lapel and having a red blinking light flash to indicate that the camera has been initiated so that if the user is walking down a dark lane and feels scared, a potential attacker will know the handset is recording and potentially sending images around the user's vicinity every five seconds to a trusted friend who could call the police. The user can decide when to initiate this; the attacker knows he/she is not alone.

7. Handset with Drop Sensing App

Dropping a phone can be very distressing for a blind or partially sighted person. Handsets usually include a solid-state accelerometer and the particular type of accelerations associated with a handset falling and then hitting a hard surface give a good indication of when the handset has been inadvertently dropped. An app (possibly downloaded from an application store like the iPhone app store or Android Market) could use that acceleration data and then, to facilitate the user finding the phone, the app could cause the handset to ping or make some other sound; the display could also flash.

### 8. Multiple Microphones to Accurately Detect a Tap Source

Although the touch screen provides good touch-based control, it is possible to extend the concept of touch control to other surfaces of the handset. For example, the whole back area of a mobile phone could be used for multiple tapping and ‘swyping’ (possibly with haptic sensory feedback). So anywhere on the phone surface becomes a potential source for activation of UI events through tapping the selected surface. The surface may be flat, contoured and finished in a variety of surface treatments and materials. The user could for example tap twice on the back of the phone (anywhere on the back, or in a specific region, which could be user-set) to turn it on, or to open the password-based unlocking feature. The user could program a specific sequence, rhythm or pattern of taps to act as the password (a feature that might be appealing even for sighted users).

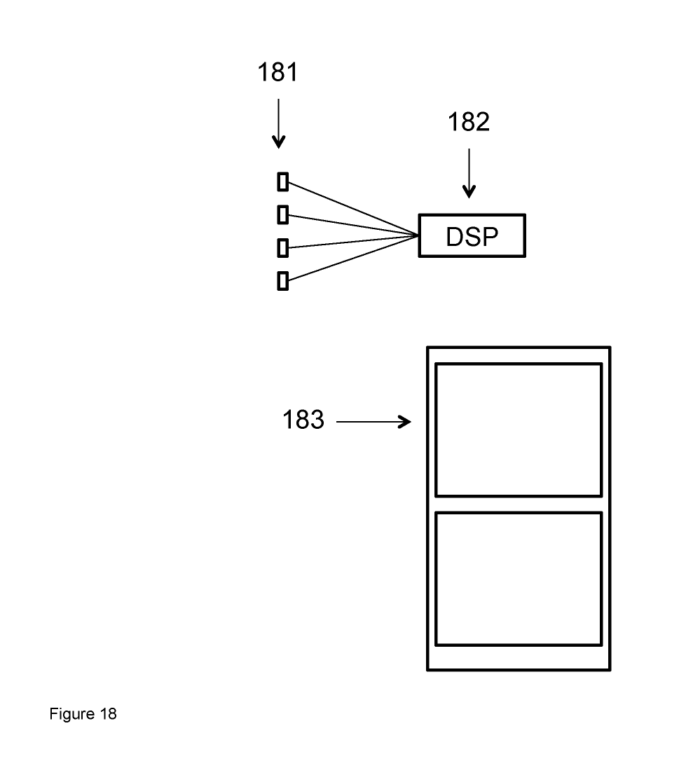

FIG. 18 schematically depicts multiple microphones 181, connected to a DSP 182. The mechanical structure of the phone is designed to optimise the acoustics paths 183 to allow multiple microphones to accurately determination the location of the ‘tap’ and thus the triggered function.

9. Colour Sensing Software—the Colour Name is Spoken with Tonal Variations

The handset speaks the colour of objects/scenes it is imaging with its camera (the camera may be integrated, tethered, separable or separate).
Easy to start with simple zones for point and select
Colors will be represented in a variety of feedback modes
Spoken word, special tones, changing pitch and unique pulsing/other rhythms

| | |
|---|---|
| Light color | Higher pitch |
| Bright color | |
| Solid color | |
| Deep color | |
| Dark color | Lower pitch |

Sound is coordinated via pitch and tone
The spoken word needs to be coordinated with a pitch and or unique tone
Haptics can be used to add an additional layer of detail to communicate each of the sensed observations.
The color names need to be stated clearly. Too many color references will not work. Careful references to nature can work like blue-green relative to sea green.

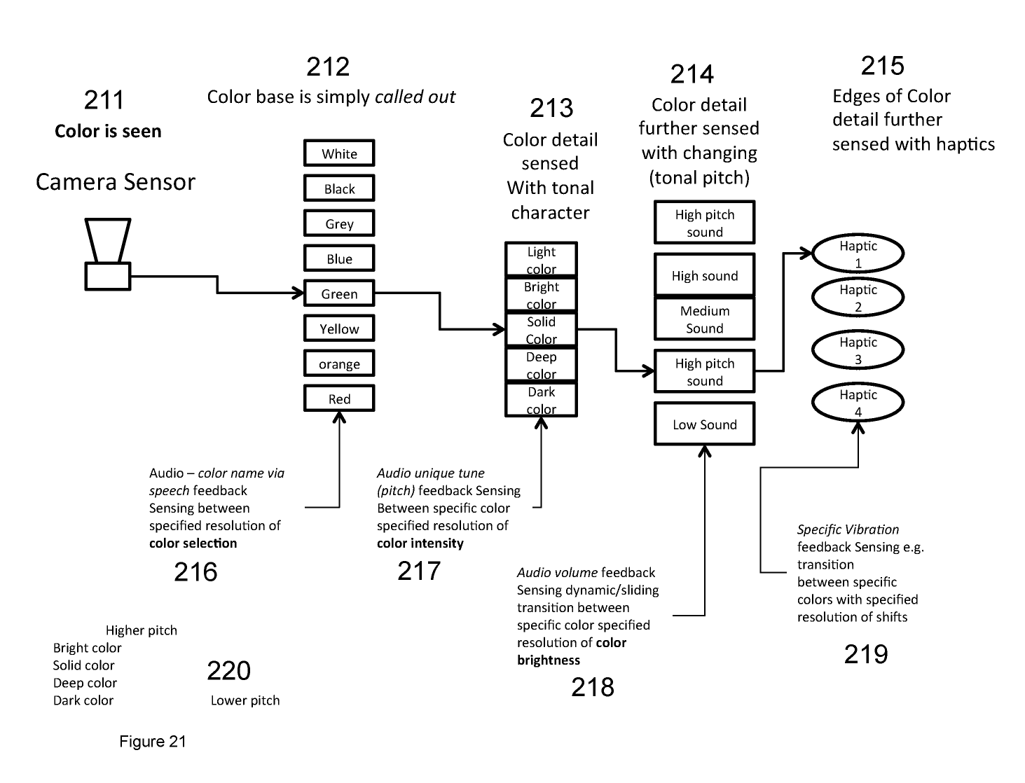

FIG. 21 shows the following flow: the camera sensor detects a colour 211 and the colour base is simply called out 212, with speech synthesis software. Sensing 216 is between specified resolutions or discrimination of different colors (white, black, grey, blue, green, yellow, orange, red). At a greater level of sophistication, the audio feedback of the sensed colour can be given different tonal characteristics, depending on the colour tone (e.g. a bright colour is described with a higher pitch than a darker version of that colour—so a bright red would be described audibly with a high pitched ‘orange’, whereas a darker orange would be described with a lower pitched ‘orange’). So colour intensity is sensed 217 for a specific colour and the colour audibly output 213 with the appropriate pitch.

Audio volume feedback is also possible: by sensing the dynamic/sliding transition between specific colors and their brightness 218, that transition can be audibly encoded by changing the volume and/or pitch. In more general terms, any of the conventional parameters of chroma, saturation, purity, and intensity can be audibly encoded in a suitable manner (e.g. tone, whether volume, whether rising or falling). Haptic feedback 219 can be provided to encode transitions between specific colours, such as the edges of colour regions 215.

### APPENDIX 1

### Other Concepts

### 1. UI

Any aspect of size, contrast, colour scheme can be personalized either manually or automatically to the user's profile. Also, as the user's faculties are likely to change, there is a ‘continuous’ adjustment mechanism to enable all of these UI aspects to be easily updated. Customisation of calibration of all UX is possible; for example, colour blindness correction.

GUI may be consistently simplified to show just 6 rows, each with just a single function (indicated by a large icon and text).

### 2. Combining Touch and Physical Buttons in Hybrid UI

This can be key to physical differentiation. Having a combination of taps on the back surface of the phone to indicate you are about to go outside, which then reconfigures the UI e.g. changes priority of the contacts list, makes the ring tone louder.

### 3. Audio Tuned to Users Audio Profile

Ability to download eye test and hearing test results at the opticians onto the mobile handset and retune the display colours, fonts, sound of screen reader and ring tone. It is also possible to include a built in text reminder of the follow on appointment at the opticians.

4. Haptics Combined with Physical Features

The physical buttons do not need to move due to capacitive switches on each key—this will enable a lower cost product that is more robust.

IR temperature sensor can be used to control and enhance the colours displayed—for example to make contact book pictures enhanced, to aid recognition. This could be combined with a distance sensor. A motion detector in the handset can be very useful—for example as the user hovers around the handset with his or her hand looking for the handset—the waving can be detected. Bluetooth syncing would be possible if the handset is in another part of the user's house. A key fob could vibrate or whistle louder when near the handset.

### 5. Object Recognition (Enhanced Reality)

Specifically being able to sense size relative to a standard mass (large to small), maybe using known things for calibration (dog, person, small car, truck, bus, airplane, small house, apartment building, high rise, mountain).

### 6. Object Recognition

Via again use of vibration to indicate size/mass. Much of this will be tied to location based services (if the phone knows where you are and what you are pointing at). Text enhancement—using camera as magnifier. This would be a really useful tool for seniors who need glasses.

### 7. Colour Interpretation as Music (Ie Major Artist)

Also thought of as simple tones representing color characteristics etc.

### 8. Single Handed Operation of Touch

### 9. Screen Magnifier/Simple UI/Create Real Ease of Seeing/Make Screen Magnifier Very Simple

Recognizing objects/blocks of things—haptic feedback when you move from object to object.

10. Hue View—can be Used to Allow a Blind Person to Ensure they Select Clothes which Match

1. Mobile computing device including a physical feature which defines the centre-line of the device across the short and/or long axes of the device.

2. The device of claim 1 in which the physical feature is a ridge.

3. The device of claim 2 in which the ridge is distinctly coloured.

4. The device of claim 1 where the feature locates or leads to the position of a camera lens.

5. The device of claim 1 where the body of the device has a left-right asymmetrical shape.

6. The device of claim 5 including a bumper that is asymmetrically arranged around the device.

7. The device of claim 6 where one or more sockets are positioned at the end of the bumper.

8. The device of claim 6 where one or more physical buttons controlling device functions are positioned in the bumper.

9. The device of claim 1 where the device includes a front facing speaker grill with multiple front-facing audio output ports that lie adjacent to the keys of the physical keyboard.

10. The device of claim 9 where the device includes a keyboard with several rows of keys and there is an audio port at the end of each row of keys.

11. The device of claim 1 where the device includes physical keys with haptic feedback.

12. The device of claim 11 where the device includes a touch screen display with haptic feedback.

13. The device of claim 12 where the display and keyboard are vibrationally insulated from the rest of the device by, for example, a flexible mounting.

14. The device of claim 1 where, when the user touches a physical key, then there is both visual confirmation feedback on the display, and audio confirmation feedback.

15. The device of claim 14 where actual selection of the key is then confirmed with haptic feedback.

16. The device of claim 1 where the device has a separate camera that is connected via a flexible leash to the device.

17. The device of claim 1 where the device includes a drop sensing app that automatically triggers an audible alert to assist the user in locating the device after it has been dropped.

18. The device of claim 1 where the device has multiple microphones to accurately detect a tap source's location on the handset casing.

19. The device of claim 1 where the device includes colour sensing software and colour names of objects imaged by the device are spoken with tonal variations, the different tones corresponding to different aspects of the colours, such as lightness.

20. The device of claim 1 where the device includes a keyboard in which all physical keys on the same row provide different touch feedback sensations from adjacent keys on that row, e.g. by being made of different materials or having a different shape.

21-30. (canceled)
